(19) United States
(12) Patent Application Publication
(10) Pub. No.: US 2014/0260780 A1
(43) Pub. Date: Sep. 18, 2014

(54) Hybrid metal fiber flywheel

(71) Applicant: Gerald Frank Simons, Bosque Farms, NM (US)

(72) Inventor: Gerald Frank Simons, Bosque Farms, NM (US)

(21) Appl. No.: 13/998,718

(22) Filed: Nov. 26, 2013

Related U.S. Application Data
(60) Provisional application No. 61/852,000, filed on Mar. 14, 2013.

(51) Int. Cl. H02K 7/02

(52) U.S. Cl. CPC H02K 7/025
USPC 74/572.12

(57) ABSTRACT

An energy storage flywheel whose energy storage capacity has been enhanced by the use of circumferentially applied composite fibers. The use of high density metal wafers being laminated with isolating low density laminations ensures maximum energy storage for a given mass and safely limits instant total energy release or the ejection of failed objects upon the event of a mechanical failure.

### CROSS REFERENCE TO RELATED APPLICATIONS

This application claims the benefit of Provisional Patent Application No. 61/852,000

### STATEMENT REGARDING FEDERALLY SPONSORED RESEARCH AND DEVELOPMENT

Not applicable

### BACKGROUND OF THE INVENTION

### Field of the Invention (Technical Field)

The present invention relates to flywheels, utilizing the mass benefits of metal, the high strength bonding capability of flexible epoxies and the structural benefits of high strength carbon composites.

### BRIEF SUMMARY OF THE INVENTION

The embodiment of the present invention is a flywheel or alternatively called a momentum wheel, assembled of structural component parts so juxtaposed as to increase the structural capability of each of the individual component thus increasing the functional capability of the assembled flywheel.

### BACKGROUND OF THE INVENTION

The energy storage capability and angular momentum of flywheels has long been recognized as a practical and efficient means to store energy and, if being held in gimbals, remains fixed in space epitomized as a conventional gyroscope. Historically flywheels were developed using solid metal configurations commonly driven by electric motors. As technology improved the speed of the flywheels was increased and ultimately reached a physical speed limit due to stresses caused by the rotational speed. When the rotational speed reaches a limit at which the stresses exceed the capability of the rotating material, it fails explosively releasing all its stored energy instantaneously.

In an effort to store more energy, flywheels were developed that were made of high strength composite fibers forming the rotating member thus extending the ability to withstand rotational stresses. The function of a flywheel depends upon the mass of the rotating body and unfortunately those fibers are light in mass and therefore little storage was obtained. The function of the flywheel is also dependent upon the square of the speed of rotating body. The solution was to increase the speed more and more until finally speeds of 50-60000 RPM were used. Running a rotating body at those speed involved enormous physical problems in bearings, aerodynamic drag losses and aerodynamic heating as well since the tip speeds were supersonic. A rotor failure was of even greater concern. The sudden release of energy stored in the wheel was explosive and potentially could cause enormous damage. Containment housings were developed that are unreasonably heavy and expensive. Flywheels of designs representing prior art, used to store energy are typically buried in underground bunkers. To minimize the aerodynamic losses, the wheel must be run in a hard vacuum to reduce aerodynamic drive forces. Hard vacuums are virtually impossible to continuously maintain as the wheel ages. Elaborate bearing configurations such as active and passive magnetic, aerodynamic, liquid, cryogenic, and other sophisticated bearing techniques have been applied, all with marginal success. The speed of flywheels used as rotating bodies in gyroscopes, since it is impractical to bury them in underground or equivalent bunkers, were limited to slower speeds resulting in large safety factors or sizes that an explosive failure could be contained. That limitation has restricted the use in applications that benefit from the use of large gyroscopes.

The flywheel of the present invention is an assembly of primarily dense materials and as such stores a large amount of energy at a rotational speed that does not benefit greatly from the use of a hard vacuum and allows the use of conventional bearings, thus avoiding the complications of the abnormally sophisticated bearings.

Flywheels of the prior art even if constructed of high strength composite fibers relied upon the strength of the rotating material to determine the maximum operating rotational speed of the flywheel. In the present invention the ultra high strength composite fibers are not the primary source of stored energy but are used as means to extend the capability of the dense material making up the rotational mass. As a rotating mass spins, the forces imposed on the rotating material cause it to increase in circumference and as it increases in circumference, the materials of the spinning mass are stretched. As the rotational speed increases, that stretching increases until the material fails and as it fails it disintegrates and instantaneously releases all its contained energy.

Random failures occur, and in prior art, when a failure occurs all the stored energy was instantaneously released. In the present invention, the mass of the rotational body is made up of assembly of circular laminations or wafers, each of which is a flywheel of itself and stores only its mass proportional share of the entire stored energy of the flywheel. If an anomaly were to occur in which that lamination were to fail, and if its fragments were to be allowed to move from their fixed, bonded in place location, only the small amount of energy that the failed lamination had contained would be released. In prior art the spinning mass was one unit; even those flywheels made of circumferentially wound fiber composites. The filaments of those circumferentially wound fiber wound wheels were bonded into a single mass. In some cases, layers of wound fiber were bonded into a pseudo laminations but a failure of a fiber would cause the entire mass to disintegrate. Descriptions are made in the prior art of having a laminated structure but in those embodiments, the laminations are really only circumferentially wound layers of continuously wound fibers creating a layered structure. In the present invention, each of the circular high density laminations is bonded to a low density, but structurally adequate adjacent circular lamination If a high density lamination were to fail, upon failure the circumferential stress (hoop stress) is instantly relieved when the lamination fractures. That leaves only centrifugal force operating upon the failed section. The entire interfacing surfaces of both the high density laminations and the low density lamination s are securely bonded together and because of the strength of the bonding material resulting from the large area of contact, the centrifugal force generated by the rotational action of the spinning wheel is only a fraction of the strength of the bond. In addition, each of the high density lamination is wrapped with a band of high strength composite fibers that have been wound under tension circumferentially around the high density lamination. As a result of these two restraining actions, upon the event if a structural failure, the fractured piece of the high density lamination will remain in place and no energy will be released. In the event of a structural failure of a low density lamination, because of its low mass, the resulting centrifugal force of the failed section is of such low magnitude that its bond to the high density lamination easily holds it immobile. Ultimately with fatigue and temperature and stress cycling, an unbalance might be detected and the use of the flywheel terminated.

Metal flywheels of prior art are typically made by a forging process and then finish machined to detail the various thickness configurations of the specifically designed wheel. In order to maximize its functional performance and minimize its stresses the wheel is designed with a thicker hub, then a thinner section extending from the hub to a thickened rim. Each flywheel undergoes large non recurring engineering and tooling costs. The flywheel of the present invention provides for extreme flexibility of application since it is simply an assembly of high density material such as steel that is rolled to a flat dimension, cut to a circular shape using conventional cutting tools, bonded to laminations of less dense material using existing processes. Its functional capacity is determined by the number of laminations and the radius of their circular shape. The rolling process done at the steel mill is effectively a forging process. Being of such simple construction allows the configuration of the flywheel to easily be built to accommodate whatever functional requirement exists.

### DRAWINGS

FIG. 1 shows the flywheel configurations

FIG. 1a shows a laminated fiber wrapped flywheel module mounted on a shaft,

FIG. 1b shows two of the same type module mounted on the same shaft with a third module ready to be mounted.

FIG. 2 shows flywheel construction details

FIG. 2a shows a side view of the circular flywheel.

FIG. 2b is a section of the flywheel module showing the details of its construction.

FIG. 2c shows the expanded metal sleeve used to transfer the rotational drive forces.

FIG. 2d is an enlarged detail of the assembly of the laminations and the fiber wrapping.

FIG. 2 e is a detail of the fiber and its associated epoxy encapsulate

FIG. 2 f shows a detail of the bonding material in relation to the laminations which it bonds

### REFERENCE NUMERALS

10 Outer lamination
12 high density lamination
14 Inner low density lamination
16 Split sleeve
18 Fiber
20 Encapsulating Epoxy
22 Bonding material
24 Axle shaft
26 Attachment mechanism

### DETAILED DESCRIPTION

FIG. 1a shows a laminated fiber wrapped flywheel module mounted on a shaft. FIG. 1b shows two of the same laminated fiber wrapped flywheel modules mounted on the same shaft with a third module ready to be mounted on the same shaft. Each module, when mounted on the shaft is a complete flywheel and contains a given amount of stored energy. Its functional characteristics are established by its radius and the mass that results from the number of laminations. By adding modules to a common shaft the functional capability of the total flywheel assembly may be increased in increments to meet the design objective. Moreover mounting space may be an issue and to accommodate such limitation the radius of the module may be altered as necessary to fit the available space. The modular assembly with the ability to select the desired radius provides enormous application flexibility.

The flywheel module is an assembly using alternate circular laminations of different density materials bonded together with a high strength bonding material and with the high density lamination being wrapped under tension with a high strength composite fiber.

FIG. 2a shows a view of the circular shape of the flywheel module with the outer circular lamination being shown and the inner laminations being a dashed circle. FIG. 2b shows the assembly of a series of laminations with a solid disc lamination of lesser density being shown as the outer element of the assembly, then a lamination of high density, and then another thinner solid disk lamination of the lesser density and thereafter, that assembly process is continued until there are a number of laminations. In the preferred embodiment, there are two outer laminations of lesser density but of greater thickness forming the outer surfaces with alternate inner laminations of high density with those laminations separated from each other by the thinner lesser density laminations. In other embodiments, any number of alternating wafers and diaphragms may be used to complete a module. Each of the laminations is bonded to the adjacent lamination by high strength bonding material.

Refer to FIGS. 2a and 2b. Outer lamination 10 is a solid disc of lightweight material, typically aluminum, fiber composite or other appropriate material, with a center hole and whose outer diameter is slightly larger than the outer diameter of High density lamination 12.

A flywheel must be balanced in both rotational planes in which it runs. Manufacturing anomalies that prevent unbalance of the flywheel cause an initial unbalance. In the balancing process, material is removed from specific locations of the assembly to obtain the required balance. The removal of that material must not affect the structural integrity of the wheel. Accordingly, Outer lamination 10 is of sufficient thickness that material may be removed from its surface, making it thinner in specific locations as necessary to allow the assembled wheel to become balanced.

High density lamination 12 is a high strength metal material, typically high strength steel with a center hole. The dimension of the center hole in Outer laminations 10, Inner low density laminations 14 and high density laminations 12 allows Outer laminations 10, Inner low density laminations 14 and High density laminations 12 to fit over Split sleeve 16 and Attachment mechanism 26.

Split sleeve 16 is a mild steel sleeve of dimension such that it its outer diameter is slightly larger than the hole in the assembly of laminations. When installed it is lightly compressed and when Attaching mechanism 26 is installed, it ensures that the interface between Shaft 24 and Attaching mechanism 26 is complete.

FIG. 2 D shows an Outer lamination 10 bonded by Bonding material 22 to High density lamination 12, which in turn is bonded by Bonding material 22 to Inner low density lamination 14 which in turn is bonded by Bonding material 22 to another high density lamination 12—with this process continuing until four High density laminations 12 have been placed. Another outer lamination 10 is then assembled to the last remaining High density lamination 12 thus forming the other outside surface of the flywheel module. As shown in FIG. 2 F, the entire assembly of alternating High density laminations 12, and Inner Low density laminations i4 is held together with Bonding material 22. Bonding material 22 may be any flexible bonding material of predetermined adequate bond strength capability, with its curing process requiring thermal exposure of the metal elements of the flywheel to temperatures below that temperature which affects the structural characteristics of the metal elements of the flywheel assembly.

As shown in FIG. 2D, because the outer diameter of Outer laminations 10 and Inner low density laminations 14 is larger than the outer diameter of High density laminations 12, a pocket is formed at the outer periphery of the assembly. Fiber 18 which is encapsulated by Encapsulating epoxy 20, is wound under tension into that pocket as shown in FIG. 2E, until the pocket is full. FIG. 2E shows the cross-section of the fiber pack. The strands of Fiber 18 together with encapsulating Epoxy 20 fill the pocket at the outer periphery of High density lamination 12. With Fiber 18 being encapsulated and held under tension, Encapsulating epoxy 20 is allowed to cure. When Encapsulating epoxy 20 is fully cured, the assembled laminations and wafers are mounted on Axle shaft 24.

Attachment mechanism 26 that typically is a commercially available Ringfeder is installed over the outer periphery of Axle shaft 24 as shown if FIG. 2B. A Ringfeder is a donut shaped device that expands peripherally when its self contained bolts are tightened. It therefore “wedges” itself between Axle shaft 24 and Split sleeve 16. Split sleeve 16 is shown in FIG. 2C. Split sleeve 16 expands as the Ringfeder is tightened and firmly attaches all the diaphragms and wafers to Axle shaft 24. The expanding bolts of Retaining mechanism 26 are tightened to firmly attach the assembly as shown in FIGS. 2A and 2B to Axle shaft 24. In other embodiments, the assembly of laminations may be attached to Axle shaft 24 by means other than the conventional Ringfeder retaining mechanism 26.

In the entire manufacturing process none of the metal elements are allowed to be exposed to heat processing such as flame cutting, welding or brazing. The laminations, as formed have the structural characteristics of forged materials since they are roll-formed and any exposure to heat reduces their structural capability. Additionally, other than the center hole providing lamination mounting capability, no holes or penetrations of an kind are allowed in the surfaces of the laminations. Any such interruption of the surfaces alters and deteriorates the ability of the lamination to accept its load stress.

Thus the flywheel is assembled in modular increments on Axle shaft 24 providing means by which the assembled flywheel may be driven from any rotational source.

### FUNCTIONAL DESCRIPTION OF THE PREFERRED EMBODIMENT

A flywheel is designed to store kinetic energy or angular momentum which are directly related. The magnitude of its storage is a function of the speed of its rotating mass and the distribution of that mass relative to the outer diameter of the wheel. The faster it spins the more energy it contains. The further out the center of mass is from the center of rotation, the larger amount of energy it can store. The preferred embodiment employs a solid disc. Other embodiments may employ innumerable spoke configurations to distribute the mass; therefor any spoke configuration delivering the greatest energy and capable of withstanding the upper design speed is acceptable in other embodiments. The function of a flywheel is to store energy or maximize momentum. The performance of a flywheel is measured as the amount of energy it is capable of storing with its momentum being a direct derivative of that stored energy. The amount of energy it is capable of storing is a function of is rotational speed and the configuration of its mass. In the preferred embodiment the mass of the flywheel is distributed to maximize its ability to store energy. The speed at which the flywheel may be rotated is determined by its capability to resist structural failure derived from stresses that increase as the rotational speed of the flywheel increases. As the flywheel rotates, internal stresses are developed. Hoop stress is the stress that is tangential to the circumference of the wheel and as the wheel rotates the hoop stress increases and in accordance with Hook's law, causes the circumference of the wheel to increase. As the circumference increases the diameter must also increase by the relationship of Pi thus creating stresses in the wheel extending from the hub to the periphery. In the embodiment of the flywheel of the present invention, Fiber 18 that has a much higher modulus than the steel of high density lamination 12, is wrapped under tension around the periphery of the laminations 12 thus reducing the ability of High density laminations 12 to increase in circumference as the speed of the wheel increases and thus reducing the hoop stresses in High density lamination 12. Because Fiber 18 is capable of accepting stresses greater than those of the material of High density lamination 12, the speed of the wheel can be increased as a function of the ratio of the strength (Modulus of elasticity-Young's modulus) of Fiber 18 to that of High density lamination 12 thus allowing the wheel to store more energy. Fiber 18 is wrapped under tension around High density lamination 12 thus causing a tension preload on Fiber 18. Typically that preload would be the order of 5% of the ultimate fiber tensile strength. As the wheel spins and the circumference of the wheel tends to increase, the tension of Fiber 18 increases. Having it preloaded assures intimate contact with High density lamination 12 at the instant the wheel begins to expand.

In the event that the wheel was driven at a speed greater than the speed that generated allowable stresses in lamination 10,12 or 14, or an anomaly were to occur in the material of any of those items, a structural failure could occur. High density lamination 12 is wrapped with a high modulus fiber limiting its hoop stress, but there is an upper limit of rotational speed that yields an acceptable safety stress margin. That speed is considered to be the maximum allowable, rotation speed of that configuration of flywheel. The density of laminations 10 and 14 is significantly lower than the density of high density lamination 12 and at the maximum allowable rotational speed set by the acceptable stresses in lamination 12, because of their low density their stresses at that speed have equal to or greater safety margins than those exhibited by lamination 12.

Statistically the failure would occur first in only one High density lamination 12. Since there are many laminations 12 representing the entire mass of the wheel, the failure of one lamination 12 would release only that portion of the stored energy represented by the fraction of the mass of the wheel represented by the failed High density lamination 12. The stresses in laminations 10 and 14 are always lower than the stresses in lamination 12 due to the reduced density of laminations 10 and 14.

In order for energy to be released upon a failure of High density lamination 12, a section of High density lamination 12 must move from its position in the assembly. In order to move it must be broken to a degree that it becomes completely free of the remaining section. At the moment of fracture, all the stresses derived from hoop stress are instantly removed and the broken piece is subject only to centrifugal force. Centrifugal force is a function the mass of the broken piece and its radius from the center of rotation. High density lamination 12 could break in half or a section at the periphery could become the broken piece. In either event as the size of the broken piece increases its mass increases but also its surface held by the bonding material increases to a degree that the broken piece is held firmly in position by the bonding force holding it to laminations 10 and/or 14. In addition the outer periphery of any potentially broken piece is also held in position by being wrapped by Fiber 18. As a result, even if a lamination 12 sustained a failure, there would be no release of energy since the broken piece remains in position in the assembly. Thus not only do the low density laminations prevent the explosive loss of energy upon a lamination failure, they also prevent that failure from cascading throughout the entire assembly of laminations.

Therefore it can be seen that the capability of the wheel to store energy is vastly improved by the carefully a designed application of high strength composite fiber that reduces the stresses in the material thus allowing a greater rotational speed with associated increased energy storage capability. By bonding the laminations together and fiber wrapping, an explosive failure is avoided but even in the highly improbable case in which a failed lamination were to escape, the explosive energy is limited to the small portion of the total energy of the wheel that is contained in that single failed lamination.

t.

### CONCLUSIONS, RAMIFICATIONS AND SCOPE OF THE INVENTION

It can be seen that the capability of the flywheel to store energy has been significantly extended by the addition of a high strength fiber wrap applied to augment the natural structural characteristics of the basic high density laminations, and by the implementation of unblemished, roll forged disc laminations. Additionally, in prior art, the explosive total release of energy upon the event of a structural failure has caused flywheel installations to be contained in revetment-like enclosures. In the embodiment of the present invention, the stored energy is shared by the number of laminations. Each contains only a small fraction of the total stored energy of the flywheel. Statistically only one wafer will fail first. Because it is separated from all other laminations by a less dense lamination, its failure does not cause the failure of any other lamination. Further each lamination is held in place by the bonding material that bonds all the laminations together without affecting their structural characteristics. The bonding material is of such high strength that even if the failed wafer were to break in half the bonding material would prevent it from being ejected from between the laminations. In the embodiment of the present invention. a failure begins with a crack in a lamination at its weakest point. There will be no release of stored energy because the lamination did not change its position in the assembly of laminations. It simply cracked but remained in place. The failure might not even be noticed until ultimately fatigue may extend the crack to other parts of the lamination and it may alter its position sufficiently to unbalance the wheel at high speed

Therefore it can be seen that the embodiment of the present invention not only extends the storage capability of flywheel, it also removes the hazard of instant release of stored energy.

I claim:

1. A flywheel assembly comprising one or more modules mounted on a single shaft, with each module comprising four or more high density, homogenous, metal, circular laminations and 5 or more low density homogenous, metal, circular laminations bonded together and forming means to circumscribe high strength composite fiber under tension applied to improve the structural capability of the lamination to which it is applied.

2. The module of claim 1 wherein said single shaft is made of high strength steel which provides mounting facility for said modules and provides for rotational drive force to be applied to said flywheel or received from said flywheel.

3. The module of claim 1 wherein said high density laminations are made of steel alloy, roll formed, except for its center hole contains no penetrations and is configured without exposure to temperatures altering its structural characteristics whereby maximizing its energy storage and minimizing its failure potential.

4. The module of claim 1 wherein said low density laminations are made of aluminum, roll formed, except for its center hole contains no penetrations, and is configured without exposure to temperatures altering its structural characteristics whereby maximizing its ability to capture and hold a fractured lamination segment and preventing a cascading failure.

5. The module of claim 1 wherein said bonding material bonding the high density laminations to the low density laminations may be any flexible bonding material that retains its bond strength for long periods of exposure to natural environments and is cured at temperatures that do not affect the structural characteristics of the metal flywheel components

6. The module of claim 1 wherein said means to circumscribe high strength composite fiber is a pocket formed by the differing diameters of the Low density laminations and the High density laminations and with the width of the high density lamination whereby the strength of the high strength composite fiber being applied under tension and circumscribing the High density lamination is transferred to restrain the stresses developed in the High strength lamination while in rotation.

7. (canceled)
